(19) United States
(12) Patent Application Publication
(10) Pub. No.: US 2005/0177256 A1
(43) Pub. Date: Aug. 11, 2005

(54) Addressable loudspeaker

(76) Inventors: Peter Shintani, San Diego, CA (US); Pablo Caballero, Chula Vista, CA (US)

Correspondence Address: Steven L. Nichols;Rader, Fishman, & Grauer PLLC, River Park Corporate Center One, River Front Pkwy., Ste. 150, South Jordan, UT, 84095, US

(21) Appl. No.: 10/774,915

(22) Filed: Feb. 6, 2004

(51) Int. Cl. G06F 17/00; H04B 3/00

(52) U.S. Cl. 700/94; 381/77

(57) ABSTRACT

A network includes an audio signal producing device, a content distributor communicatively coupled to the audio signal producing device, a router, a network communication medium communicatively coupling the content distributor and the router, and a plurality of addressable loudspeakers communicatively coupled to the network communication medium, wherein each of the addressable loudspeakers are configured to function as a network peripheral in the home network.

### BACKGROUND

There are many ways to make and present a sound recording. The simplest method, and the one used in the earliest sound movies, is called monaural or simply mono. Mono means that all the sound is recorded onto one audio track or channel (a single spiraled groove in a record, for example, or a single magnetic track on a tape), which is typically played on one speaker.

Two-channel recordings, in which sound is played on speakers on either side of the listener, are often referred to as stereo. Two-channel sound is the standard format for home stereo receivers, television, and frequency-modulation (FM) radio broadcasts. The simplest two-channel recordings, known as binaural recordings, are produced with two microphones set up at a live event (a concert for example) to take the place of a human's two ears. When listening to these two channels on separate speakers, the experience of being present at the event is recreated.

Surround recordings take this idea a step further, adding additional audio channels so that sound comes from three or more directions. While the term “surround sound” technically refers to specific multi-channel systems designed by Dolby Laboratories, it is more commonly used as a generic term for theater and home theater multi-channel sound systems.

In a typical home environment, there may be several loudspeakers serving in either a stereo or a surround sound configuration. Traditionally, each loudspeaker has been connected to the surround sound system via a pair of wires. When serving in a stereo configuration or as speakers for a television, two speakers serve as the left and right components. In a typical home theater setup, there may be three additional loudspeakers: front center, rear left, and rear right. In a typical home theater setup, the rear speakers would be furthest away from the amplifier. Consequently, two pairs of wires would have to traverse the room from the amplifier to each speaker, creating both a safety hazard and an eyesore.

Additionally, some home network configurations include multiple loudspeakers distributed throughout a home. In these network configurations, each loudspeaker is coupled to the system through an independently run and unsightly control wire. However, in a home with multiple living areas, this additional need for routing independent wires to each loudspeaker may be unsatisfactory to a user.

### SUMMARY

A network includes an audio signal producing device, a content distributor communicatively coupled to the audio signal producing device, a router, a network communication medium communicatively coupling the content distributor and the router, and a plurality of addressable loudspeakers communicatively coupled to the network communication medium, wherein each of the addressable loudspeakers are configured to function as a network peripheral in the home network.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a simple block diagram illustrating a home theatre configuration according to one exemplary embodiment.

FIG. 2 is a block diagram illustrating a speaker configuration including an addressable loudspeaker according to one exemplary embodiment.

FIG. 3 is a simple block diagram illustrating the internal components of an addressable loudspeaker according to one exemplary embodiment.

FIG. 4 is a flow chart illustrating a method for transmitting audio to an addressable loudspeaker according to one exemplary embodiment.

FIG. 5 is a flow chart illustrating a method for assigning a unique identifier to each component of an addressable loudspeaker system according to one exemplary embodiment.

FIG. 6A is a block diagram illustrating a request for unique identifiers in an addressable loudspeaker configuration according to one exemplary embodiment.

FIG. 6B is a block diagram illustrating an identifier assignment in an addressable loudspeaker configuration according to one exemplary embodiment.

FIG. 6C is a block diagram illustrating the transmission of packetized audio data according to one exemplary embodiment.

FIG. 7 is a simple block diagram illustrating the internal components of an addressable loudspeaker according to one exemplary embodiment.

Throughout the drawings, identical reference numbers designate similar, but not necessarily identical, elements.

### DETAILED DESCRIPTION

The present specification discloses exemplary systems and methods for providing an addressable loudspeaker. More particularly, according to one exemplary embodiment, a loudspeaker is configured with a modem and an amplifier in order to allow a router or other signal directing device to selectively transmit audio data to the addressable loudspeaker. Both the structure and the implementation of the present system and method for incorporating an addressable loudspeaker in a speaker network will be disclosed in detail below.

As used in the present specification and in the appended claims, the term “loudspeaker” is meant to be understood broadly to include any object that may be used to produce sound by the movement of air in response to a variable current. Additionally, the term “router” is meant to refer to any device or, in some cases, software in a computing device, that determines a network point to which a packet should be forwarded toward its destination. A router may decide which way to send each information packet based on its current understanding of the state of the network(s) it is connected to. A “packet” or “data packet” is meant to be understood broadly as any discrete segment of data. Data signals are typically “packetized,” meaning that the data of a message or signal is divided into discrete “packets” or segments of data. Each packet includes a header that identifies the message or object of which that packet is a part and identifies the position of that packet's data within that message or object. Consequently, a receiver of the message can collect the packets of the message or object and reassemble the packetized data into the original message or signal that was transmitted.

In the following description, for purposes of explanation, numerous specific details are set forth in order to provide a thorough understanding of the present system and method for providing an addressable loudspeaker in a speaker configuration. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

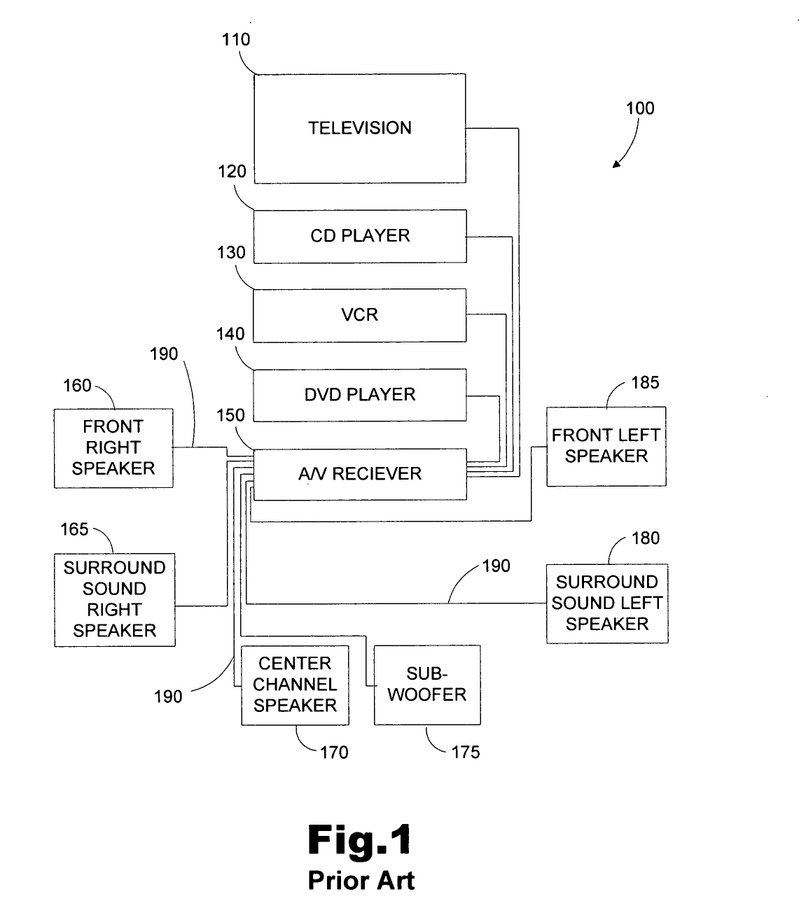

FIG. 1 illustrates a surround sound system according to the prior art. As shown in FIG. 1, a traditional home-theater system (100) includes an A/V receiver (150) to which a number of audio and video components may be attached. These components may include a videocassette recorder (VCR) (130), a digital video disc (DVD) player (140), a television (110) (e.g., a high-definition or a digital television), a compact disc (CD) player (120), a tape deck, a tuner, a phonograph, an auxiliary amplifier, and/or an upgrade component in order to provide surround sound. As for outputs, which are typically connected to loudspeakers, conventional A/V receivers (150) have two main or front channels (right (160) and left (185)) as well as a number of surround sound channels, including rear right (165) and rear left (180) channels, a center channel (170), and a sub-woofer (175). If a user is listening to the radio, the A/V receiver (150) typically provides audio output on the front right (160) and front left (185) channels only. If the user switches to an input with surround sound capabilities, such as a DVD player (140) or a surround sound broadcast, the A/V receiver (150) provides audio output on the surround sound channels in addition to the front right (160) and front left (185) channels.

As noted above, each speaker in the traditional home-theater system (100) includes an independent channel and a pair of speaker wires (190) electrically coupling the A/V receiver (150) or other system controller to the speakers. When incorporated into a home networking system, the necessity of routing a pair of independent speaker wires (190) to each loudspeaker is inconvenient and often becomes prohibitive in an existing home.

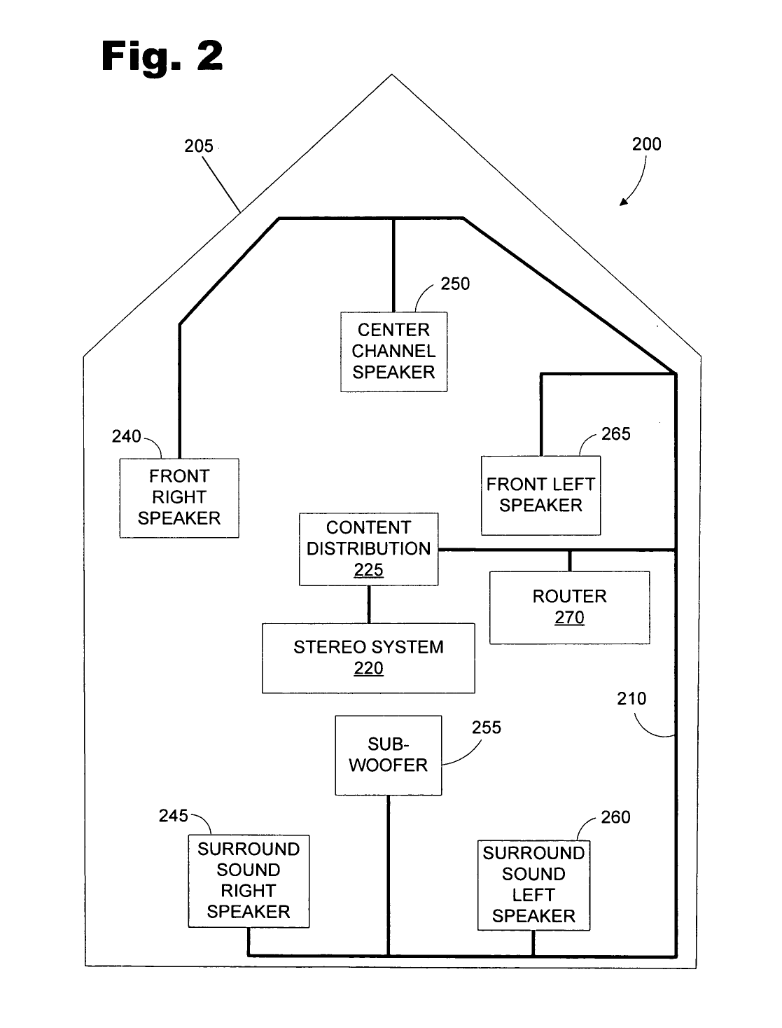

FIG. 2 illustrates an addressable loudspeaker configuration (200) at a consumer location (205) including a number of addressable loudspeakers (240, 245, 250, 255, 260, 265) according to one exemplary embodiment. According to the exemplary embodiment illustrated in FIG. 2, the present speaker configuration (200) includes a stereo system (220) communicatively coupled to a content distribution component (225). In turn, the content distribution component (225) is communicatively coupled to a network communication medium (210). Similarly, a signal router (270) is also communicatively coupled to the network communication medium (210). Moreover, a plurality of addressable loudspeakers (240, 245, 250, 255, 260, 265) are also communicatively coupled to the content distribution system (225) and the signal router (270) through the network communication medium (210).

The stereo system (220) illustrated in FIG. 2 may be any device configured to provide audio signals to an addressable speaker system (200). According to one exemplary embodiment, the stereo system (220) may include, but is in no way limited to, an A/V receiver communicatively coupled to any number of electrical audio signal producing components including, but in no way limited to, a videocassette recorder (VCR), a digital video disc (DVD) player, a television (e.g., a high-definition or a digital television), a compact disc (CD) player, a tape deck, a tuner, a Moving Picture Experts Group Layer-3 Audio (MP3) player, and/or a phonograph player. Regardless of the components communicatively coupled to the stereo system (220), the stereo system is configured to produce an audio signal and transmit that signal to the content distribution component (225) to be packetized and selectively routed to one or more of the addressable loudspeakers (240, 245, 250, 255, 260, 265) of the addressable loudspeaker system (200).

The content distribution component (225) illustrated in FIG. 2 is a component or firmware operating on a computing device configured to provide an interface to a user. The interface provided to a user presents a number of options for each addressable loudspeaker (240, 245, 250, 255, 260, 265) communicatively coupled to the present system. According to one exemplary embodiment, the content distribution system (225) is configured to provide a user with options for each addressable loudspeaker (240, 245, 250, 255, 260, 265) through a user interface (not shown) including, but in no way limited to, OFF mode, monaural mode, stereo left channel mode, or stereo right channel mode. While the exemplary embodiment illustrated above lists a number of user options for each addressable loudspeaker, any number of loudspeaker control and/or audio effect options may be presented to the user according to the present system and method. The content distribution component (225) also functions as a modulator configured to modulate incoming audio signals into packetized audio data. Upon selecting a content distribution condition for a desired addressable speaker, the audio signal may be packetized, and the sound and operation condition may then be transmitted to the desired addressable speaker with the aid of the signal router (270).

The signal router (270) illustrated in FIG. 2 may be a device configured to determine a network point to which a packet should be forwarded toward its destination. The signal router (270) may decide which way to send each audio packet based on its current understanding of the state of the networks it is connected to. The signal router (270) may also create or maintain a table of the available routes and use this information to determine the best route for a given data packet. Note that the present system may operate without the aid of a personal computer (PC). In contrast to incorporating a PC to perform the routing function, the present system and method reduces cost by incorporating a single dedicated router (270) configured to route packetized audio data. The inclusion of a dedicated router (270) eliminates computational resource allocation problems often associated with PCs. Additionally, the incorporation of a signal router (270) into the present system reduces the amount of space occupied by the system, when compared to a system that incorporates a PC, while still maintaining the functionality of incorporating addressable speakers into the system.

The network communication medium (210) that communicatively couples the above-mentioned components to the addressable speakers (240, 245, 250, 255, 260, 265) facilitates the transmission of the audio signal packet between components. As illustrated in FIG. 2 and in the remainder of the present specification, the network communication medium (210) is described in the context of a power line based network medium. A power line based network medium may be any power line infrastructure used to provide power to multiple locations in a user location. For example, a power line based network medium may include the wires in a house used to provide 110 V power to household appliances. However, the present system and method may be applied to a network incorporating addressable speakers coupled by any network communication medium capable of supporting packetized data transmission including, but in no way limited to, a wireless communication medium such as infrared or radio frequency mediums, a phone line communication medium, or an Ethernet communication medium. The exemplary embodiment illustrated in FIG. 2 is merely described in the context of a power line based network communication medium (210) for ease of explanation and because the ubiquity of electrical outlets in a residence makes it possible to place addressable loudspeakers virtually in any room.

The addressable loudspeakers (240, 245, 250, 255, 260, 265) that are communicatively coupled to the network communication medium (210) in the exemplary embodiment illustrated in FIG. 2 include a unique network identification address and may selectively be routed packetized audio signals. The components of the present addressable loudspeakers (240, 245, 250, 255, 260, 265) allow the addressable loudspeakers to work like a network peripheral with embedded capability to decode and amplify audio as well as attach themselves to a network using commonly used network protocols as described below.

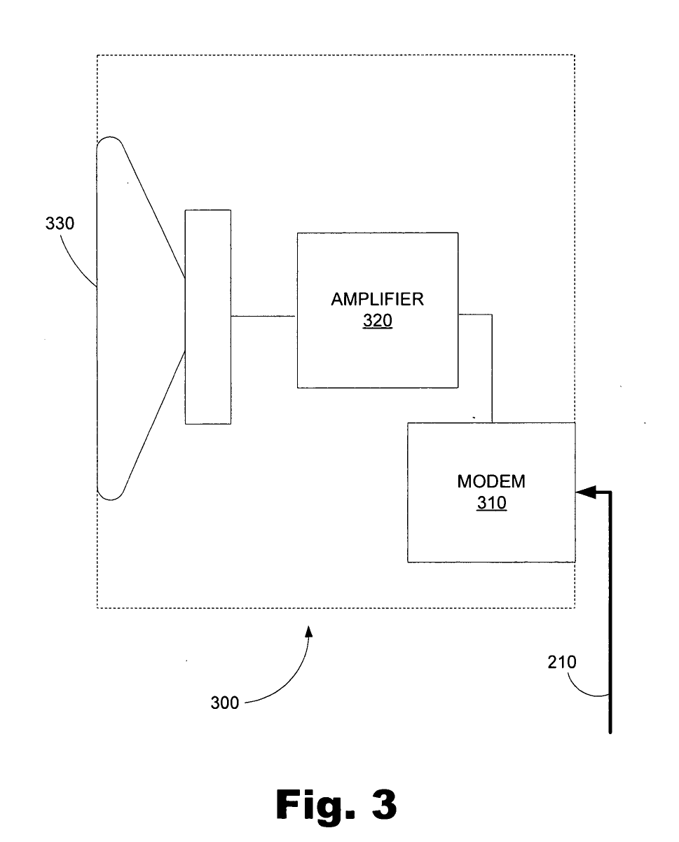

FIG. 3 further illustrates the components of an addressable loudspeaker. As illustrated in FIG. 3, one exemplary embodiment of the present addressable loudspeaker (300) includes an addressable modem (310) communicatively coupled to the network communication medium (210) previously mentioned. The addressable modem (310) is then coupled to a signal amplifier (320). The signal amplifier (320) is subsequently coupled to and configured to drive a speaker (330).

The addressable modem (310) that forms a part of the addressable loudspeaker (300) according to the exemplary embodiment illustrated in FIG. 3, includes a unique network address that allows the content distribution component (225; FIG. 2) of the present exemplary system to address packetized audio data to each addressable loudspeaker (300) independently using the router (270; FIG. 2). According to one exemplary embodiment, the unique address assigned to the addressable modem (310) is an Internet protocol (IP) address comprising a 32-bit number. Alternatively, the unique address may be, but is in no way limited to, a 48-bit Ethernet address. The unique address that is assigned to the addressable modem (310) may be preset by the modem manufacturer, user settable, and/or automatically configured by the router (270; FIG. 2) as described in further detail below. Additionally, the addressable modem (310) is configured to selectively receive addressed analog data packets representing a desired audio signal to be broadcast by the addressable loudspeaker (330) and demodulate the transmitted data packet signals into audio signals that may then be amplified and used to produce the desired audio signal in the speaker (330).

The amplifier portion (320) of the addressable loudspeaker (300) illustrated in FIG. 3 is configured to amplify the received audio signal sufficiently to drive the speaker portion (330) of the addressable loudspeaker (300). The amplifier portion (320) of the addressable loudspeaker is a power amplifier and may include, but is in no way limited to a bipolar transistor or a vacuum tube. The amplifier (320) is configured to both receive the audio signal from the modem (310) and increase the voltage of the audio signal sufficient to drive the speaker portion (330) of the addressable loudspeaker (300). Additionally, in an exemplary embodiment where the network communication medium (210) is not a power line based network, the amplifier (320) may be coupled to a secondary power source (not shown) and have a power control unit in the form of an external knob or circuitry that may be controlled by the stereo system (220; FIG. 2) through data transmitted with the above-mentioned audio signal.

The speaker portion (330) of the addressable loudspeaker (300) illustrated in FIG. 3 comprises conventional speaker hardware including, but in no way limited to, a speaker cone, a coil, and magnets. The speaker portion (330) is configured to vibrate in proportion to a change in the current of the audio signal provided by the amplifier (320) thereby producing the desired audio sound.

The present system and method for incorporating an addressable loudspeaker in a speaker configuration is described herein in the context of a surround sound speaker system. However, the present system and method are in no way limited to a surround sound system. To the contrary, the present system and method may be incorporated into any number of home or automobile networks including, but in no way limited to, home networks, security systems, monitoring systems, public address (PA) systems, and the like.

Exemplary Implementation and Operation

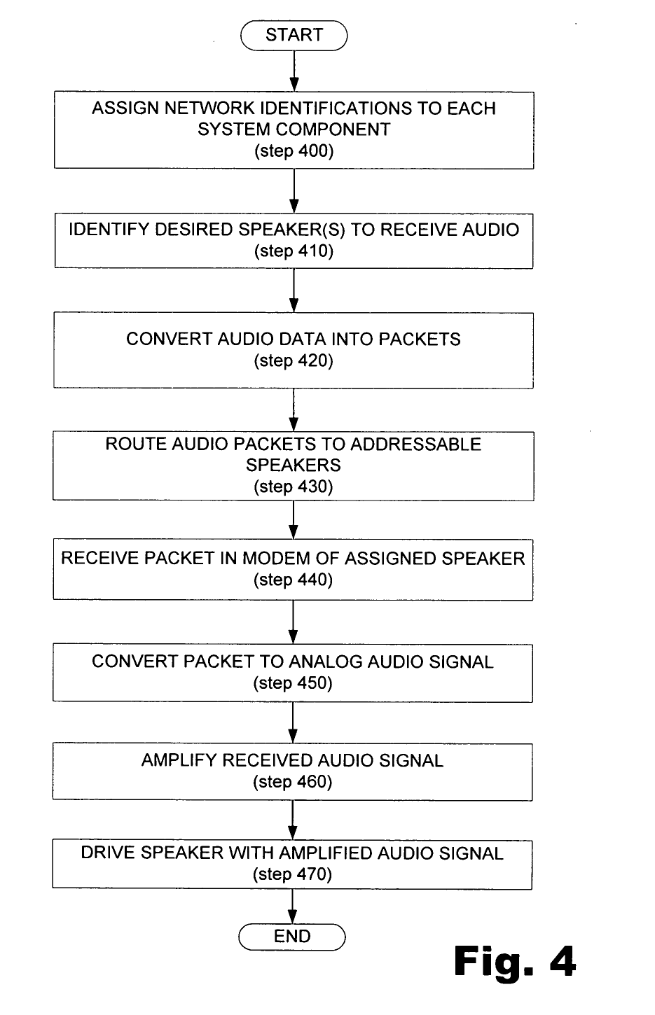

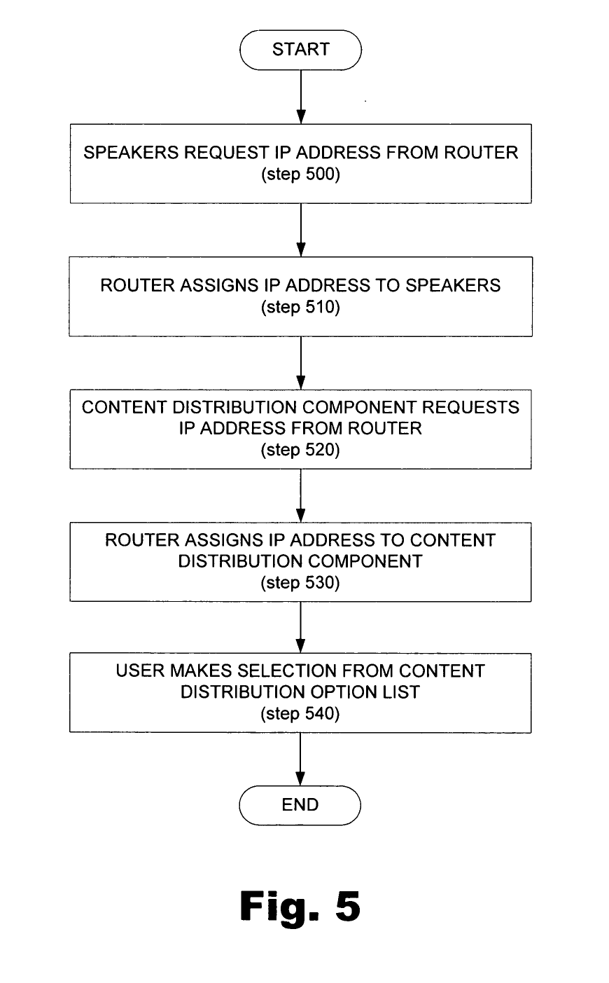

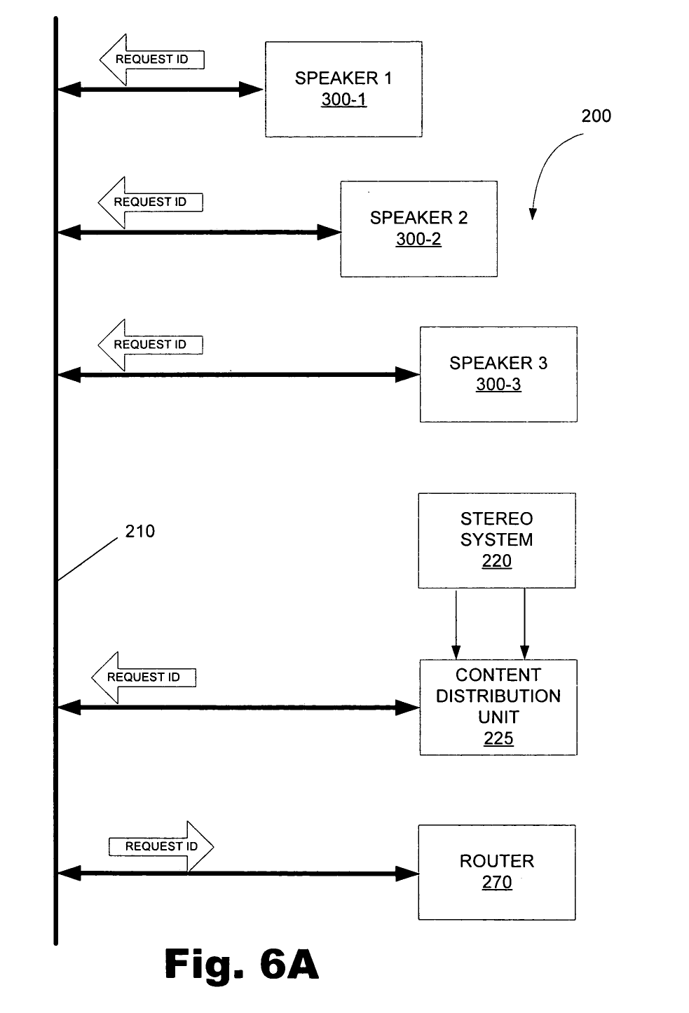

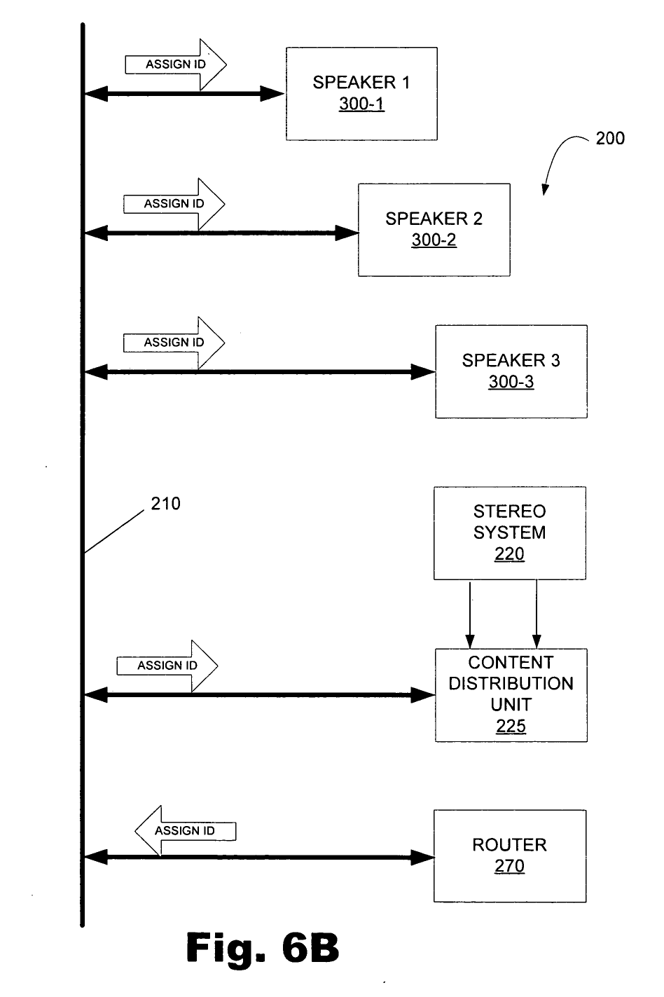

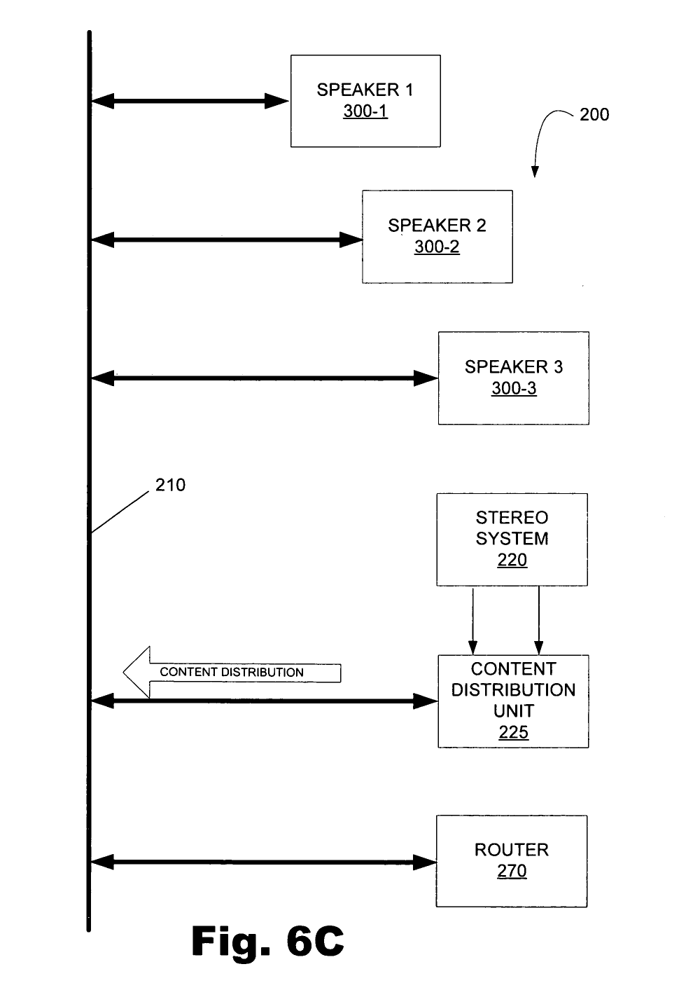

FIG. 4 illustrates a method for selectively transmitting audio signals to an addressable loudspeaker according to one exemplary embodiment. As illustrated in FIG. 4, the present method begins by assigning unique network identifications to each component communicatively coupled to the network (step 400). Once each component of the network has been assigned unique network identifications, the desired addressable loudspeakers for a determined audio signal are identified (step 410). Once the addressable loudspeakers are determined, the received audio signal is converted into packets of audio data (step 420) and the packets of audio data are selectively routed to the identified addressable speakers (step 430) by a signal router. Once received in the modems of the assigned speakers (step 440), the audio packets are converted into a continuous analog audio signal (step 450) and amplified by the amplifier (step 460). Once amplified, the analog audio signal is then used to drive the speaker portion of the addressable loudspeaker (step 470). The above-mentioned method will be further described in detail below with reference to FIGS. 5-6C.

As described above and in FIG. 4, the present method begins by assigning a network identification to each system component (step 400). One exemplary method for assigning a unique network identification to each system component (step 400) is illustrated in FIG. 5. As illustrated in FIG. 5, the assignment of unique network identifications may begin by each addressable loudspeaker requesting an IP address from the system router (step 500) according to one exemplary embodiment. The above-mentioned request (step 500) may be performed by a signal transmitted from the modem of the addressable loudspeaker. Alternatively, the request for unique network identification may be performed automatically if an addressable loudspeaker is detected on the network. Once requested, an IP address is assigned to each addressable loudspeaker by the system router (step 510). Upon assignment of an IP address to each addressable loudspeaker, the content distribution component also requests an IP address from the system router (step 520) and the system router assigns a unique IP address to the content distribution component (step 530). With all of the system components assigned a unique IP address, a user may then initiate the transmission of an identified audio signal to an addressable loudspeaker by making a selection from a content distribution options list (step 540).

FIG. 6A further illustrates the request for a unique network address by a number of addressable loudspeakers (300-1, 300-2, 300-3) and a content distribution component (225). As illustrated in FIG. 6A, each of the above mentioned components transmits a signal to the signal router (270) requesting a unique network address. As illustrated in FIG. 6B, once the request has been received by the signal router (270), a unique IP or other network identification address is assigned and transmitted to each component for storage. Additionally, the signal router (270) may also store the unique network identification addresses in a configuration table (not shown). The configuration table is a collection of information that includes data on which connections lead to a particular addressable loudspeaker (300-1, 300-2, 300-3), priorities for connections to be used, and rules for handing signal traffic.

Returning again to FIG. 4, once the system components have been assigned unique IP addresses (step 400), audio data may be prepared for selective transmission to the addressable loudspeakers. In order to prepare the audio signals for transmission to the addressable loudspeakers, the addressable speakers to receive the audio signal is identified (step 410) and the audio signal is converted into packets for transmission (step 420) by the content distribution component (225; FIG. 2).

Identification of the addressable loudspeakers to receive the audio signal may be performed via a user interface provided by the content distribution component (225). According to one exemplary embodiment, the content distribution component is configured to allow a user to designate which addressable loudspeakers are to receive a specified audio signal. According to this embodiment, the user interface presents a number of control options for each addressable loudspeaker including, but in no way limited to, OFF, monaural mode, stereo left channel mode, or stereo right channel mode. A number of additional audio and/or loudspeaker control options may also be presented by the user interface according to the present system and method.

When converting the audio signal into packets, the content distribution component (225; FIG. 2) modulates a received audio signal. When modulating the audio signal into packets, the content distribution component (225; FIG. 2) includes header information at the beginning of each audio signal packet identifying a specific addressable loudspeaker, by its IP address, which is to receive the audio data packets. Additionally, according to one exemplary embodiment, the header information may contain one of the above-mentioned control options and/or a volume level to be applied to the amplifier.

With the audio data packets appropriately formatted, they may then be routed to the identified addressable loudspeaker (step 430). FIG. 6C illustrates the transmission of an audio data packet into the present audio system (200). As illustrated in FIG. 6C, the content distribution unit (225) introduces the packetized audio data onto the network. Once introduced to the network, the signal router (270) sees the packetized data and analyzes the header information. The signal router (270) analyzes the header information of each packet searching for the recipient addressable loudspeaker's address. Once the recipient addressable loudspeaker's address is found on the packetized data, the router accesses the configuration table and matches the found address with the rules of the configuration table. The rules of the configuration table will indicate a specific direction for the identified packetized data to be transmitted. Once a path is identified by the signal router (270), the signal router will check the performance of the primary connection with a number of alternative routes and an optimal route will be selected and the signal will be transmitted. Once transmitted, the signal router (270) will then handle the next packet.

Returning again to FIG. 4, once the packetized audio signal has been transmitted to the appropriate addressable loudspeaker (step 430), the signal is received by the modem of the assigned loudspeaker (step 440). When received in the assigned loudspeaker, the modem may again check the header information of the packetized audio signal to assure that the packet is to be received by that specific assignable loudspeaker. The modem may then convert the packetized data into a continuous analog audio signal (step 450) that may then be amplified (step 460) and applied to the speaker to produce a desired audio signal (step 470) according to methods well known in the audiophile arts.

Alternative Embodiments

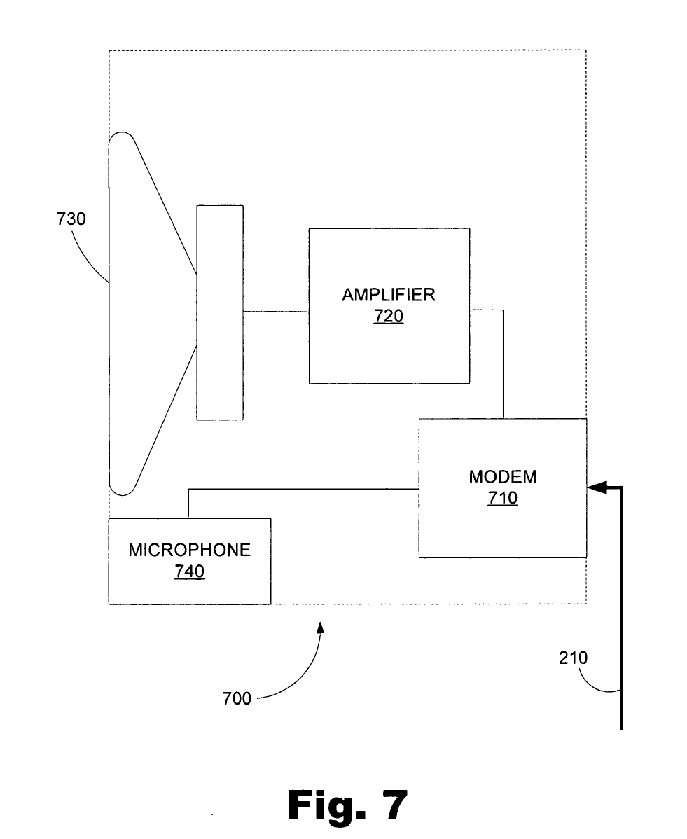

According to one alternative embodiment illustrated in FIG. 7, an addressable loudspeaker (700) coupled to a network communication medium (210) may include the components listed above. Specifically, the addressable loudspeaker (700) may include a modem (710), an amplifier (720), and a speaker portion (730). However, the addressable loudspeaker (700) illustrated in FIG. 7 also includes a microphone (740) communicatively coupled to the modem (210).

According to this exemplary embodiment, the combination of a microphone (740) and a modem (710) in each addressable loudspeaker (700) increases the utility of the addressable loudspeaker. For example, the incorporation of the microphone (740) into the addressable loudspeaker (700) makes it possible for the loudspeaker to be used as a remote microphone for system calibration. According to this exemplary embodiment, a test tone may be transmitted to a first addressable loudspeaker (700) via a router (270; FIG. 6C) as described above. When the test tone is emitted from the designated addressable loudspeaker, the other addressable loudspeakers (700) monitor the test tone levels. The test tone levels may then be modulated by the modems (710) and transmitted, via the router (270; FIG. 6C), to the stereo system (225; FIG. 2). This configuration will allow a surround sound system to calibrate itself by compensating for room acoustics, room relaxation constants, speaker placement and associated delays, as well as speaker efficiency.

Additionally, the presence of a microphone (740) in the addressable loudspeaker (700) as illustrated in FIG. 7, may allow the network to function as an intercom or as a remote security monitoring system. According to this exemplary embodiment, the sounds in a consumer location (205; FIG. 2) could be monitored anywhere there was a programmable loudspeaker (700) by modulating the picked up sounds and transmitting them, with the aid of the router (270; FIG. 6C) to a desired location.

In yet another alternative embodiment, the addressable loudspeaker configuration may vary from that illustrated in FIGS. 3 and 7. According to this alternative embodiment, the modem, amplifier, and/or microphone components of the addressable loudspeaker are not integrated with the speaker. Rather the modem, amplifier, and/or microphone components may be independent from the speaker. This configuration allows a consumer to couple the modem, amplifier, and/or microphone components to a speaker of their choice.

In conclusion, the present system and method for providing an addressable loudspeaker in a network allows for a cost efficient method for selectively transmitting audio signals to specific speakers on a network. More specifically, the present system and method reduce the cost traditionally associated with networks including addressable loudspeakers because there is no need for a personal computer since the inclusion of a router performs the packet routing functions. Elimination of a PC reduces system cost while maintaining addressable loudspeaker functionality. Additionally, the present system and method reduces network costs by eliminating the need for the routing of individual wire pairs to each and every loudspeaker in the network. Rather the presents system and method uses existing network mediums such as power lines, wireless mediums, or phone lines. Additionally, the present system and method increases the functionality of a speaker network by allowing the network to function as an intercom system or a remote security monitoring system.

The preceding description has been presented only to illustrate and describe embodiments of the present system and method. It is not intended to be exhaustive or to limit the present system and method to any precise form disclosed. Many modifications and variations are possible in light of the above teaching. It is intended that the scope of the present system and method be defined by the following claims.

1. A network comprising:
an audio signal producing device;
a content distributor communicatively coupled to said audio signal producing device;
a router;
a network communication medium communicatively coupling said content distributor and said router; and
a plurality of addressable loudspeakers communicatively coupled to said network communication medium;
wherein each of said addressable loudspeakers are configured to function as a network peripheral in said network.

2. The network of claim 1, wherein said addressable loudspeaker further comprises:
a modem communicatively coupled to said network communication medium;
a signal amplifier communicatively coupled to said modem; and
a speaker communicatively coupled to said signal amplifier;
wherein said modem is configured to be assigned a unique network identification.

3. The network of claim 2, wherein said unique network identification comprises one of an Internet protocol (IP) address or an Ethernet address.

4. The network of claim 3, wherein said content distributor further comprises a modulator configured to packetize audio signals received from said audio signal producing device.

5. The network of claim 4, wherein said content distributor is further configured to route said packetized audio signals to said addressable loudspeakers through said router.

6. The network of claim 2, wherein each of said addressable loudspeakers further comprises a microphone communicatively coupled to said modem.

7. The network of claim 6, wherein said addressable loudspeakers are configured to:
measure a test tone; and
transmit said measured test tone to said audio signal producing device.

8. The network of claim 1, wherein said audio signal device comprises a stereo receiver.

9. The network of claim 8, wherein said audio signal device is communicatively coupled to one of a video cassette recorder, a digital video disk player, a tape player, a compact disk player, an MP3 player, or a phonograph player.

10. The network of claim 1, wherein said network communication medium further comprises a power line based network medium.

11. The network of claim 1, wherein said network communication medium further comprises one of a radio frequency based medium, an infrared signal based medium, a wireless based medium, a phone line based medium, a coaxial cable based medium, or a fiber optic based medium.

12. The network of claim 1, wherein said plurality of addressable loudspeakers are disposed in multiple rooms of a house.

13. The network of claim 1, wherein said plurality of loudspeakers comprises a surround sound configuration.

14. The network of claim 1, wherein said content distributor is further configured to:
receive an audio signal from said audio signal producing device;
generate a user interface; and
packetize said audio signal based on a selection made from said user interface.

15. The network of claim 14, wherein said user interface is configured to allow a user to selectively route said audio signal to one or more of said addressable loudspeakers operating in a selectable mode;
wherein said selectable mode includes one of an OFF mode, a monaural mode, a stereo mode, a surround left mode, or a surround right mode.

16. An addressable loudspeaker comprising:
a modem configured to be communicatively coupled to a network communication medium;
a signal amplifier communicatively coupled to said modem; and
a speaker communicatively coupled to said signal amplifier;
wherein said modem is configured to be assigned a unique network identification.

17. The addressable loudspeaker of claim 16, wherein said unique network identification comprises one of an Internet protocol (IP) address or an Ethernet address.

18. The addressable loudspeaker of claim 16, wherein said addressable loudspeaker further comprise a microphone communicatively coupled to said modem.

19. The addressable loudspeaker of claim 18, wherein said addressable loudspeaker is configured to measure a speaker test tone.

20. The addressable loudspeaker of claim 19, wherein said modem is further configured to transmit said test tone measurement to a network device.

21. The addressable loudspeaker of claim 16, wherein said modem is configured to receive a plurality of packetized audio signals transmitted over a power line based network communication medium.

22. The addressable loudspeaker of claim 21, wherein said amplifier is powered by a signal received from said power line based network communication medium.

23. The addressable loudspeaker of claim 22, wherein said power line based network communication medium comprises a home power system.

24. The addressable loudspeaker of claim 16, wherein said modem is configured to receive audio signals from one of a radio frequency based medium, an infrared signal based medium, a wireless based medium, a phone line based medium, a coaxial cable based medium, or a fiber optic based medium.

25. The addressable loudspeaker of claim 16, wherein said modem is configured to:
receive a plurality of packetized analog signals; and
demodulate said packetized signal into a continuous analog audio signal.

26. The addressable loudspeaker of claim 24, wherein said amplifier is configured to amplify said continuous analog audio signal to a level sufficient to drive said speaker.

27. A surround sound system comprising:
a receiver;
a content distributor communicatively coupled to said receiver;
a router;
a system communication medium communicatively coupling said content distributor and said router; and
a plurality of addressable loudspeakers communicatively coupled to said system communication medium;
wherein each of said addressable loudspeakers are configured to be independently addressed by said content distributor.

28. The surround sound system of claim 27, wherein said addressable loudspeaker further comprises:
a modem communicatively coupled to said system communication medium;
a signal amplifier communicatively coupled to said modem; and
a speaker communicatively coupled to said signal amplifier;
wherein said modem is configured to be assigned a unique network identification.

29. The surround sound system of claim 28, wherein said unique network identification comprises one of an Internet protocol (IP) address or an Ethernet address.

30. The surround sound system of claim 29, wherein said content distributor further comprises a modulator configured to both packetize audio signals received from said receiver and selectively route said packetized audio signals to one of said addressable loudspeakers using said unique network identification and said router.

31. The surround sound system of claim 27, wherein each of said addressable loudspeakers further comprises a microphone communicatively coupled to said modem.

32. The surround sound system of claim 31, wherein said addressable loudspeakers are further configured to:
measure a test tone emitted by one of said loudspeakers; and
transmit said measured test tone signals to said receiver for system calibration.

33. The surround sound system of claim 27, wherein said receiver is communicatively coupled to one of a video cassette recorder, a digital video disk player, a tape player, a compact disk player, or a phonograph player.

34. The surround sound system of claim 27, wherein said system communication medium further comprises a power line based communication medium.

35. The surround sound system of claim 37, wherein said system communication medium further comprises one of a radio frequency based medium, an infrared signal based medium, a wireless based medium, a phone line based medium, a coaxial cable based medium, or a fiber optic based medium.

36. The surround sound system of claim 26, wherein said content distributor is further configured to:
receive an audio signal from said receiver;
generate a user interface; and
packetize said audio signal based on a selection made from said user interface.

37. The surround sound system of claim 36, wherein said user interface is configured to allow a user to select said audio signal to be selectively routed to one or more of said addressable loudspeakers operating in a selectable mode;
wherein said selectable mode includes one of an OFF mode, a monaural mode, a stereo mode, a surround left mode, or a surround right mode.

38. A home network comprising:
a means for producing an audio signal;
a means for distributing said audio signal communicatively coupled to said means for producing an audio signal;
a means for routing said audio signal;
a network communication medium communicatively coupling said distribution means and said routing means; and
a plurality of addressable loudspeakers communicatively coupled to said network communication medium;
wherein each of said addressable loudspeakers are configured to function as a network peripheral in said home network.

39. The home network of claim 38, wherein said addressable loudspeaker further comprises:
a modem communicatively coupled to said network medium;
a means for amplifying a signal communicatively coupled to said modem; and
a speaker communicatively coupled to said signal amplifying means;
wherein said modem is configured to be assigned a unique network identification.

40. The home network of claim 39, wherein said unique network identification comprises one of an Internet protocol (IP) address or an Ethernet address.

41. The home network of claim 40, wherein said content distribution means further comprises a modulator configured to packetize audio signals received from said audio signal producing means.

42. The home network of claim 41, wherein said content distribution means is further configured to route said packetized audio signals to said addressable loudspeakers through said routing means.

43. A surround sound system comprising:
a receiver;
a means for distributing audio content communicatively coupled to said receiver;
a means for routing signals;
a system communication medium communicatively coupling said content distribution means and said signal routing means; and
a plurality of addressable loudspeakers communicatively coupled to said system communication medium;
wherein each of said addressable loudspeakers are configured to be independently addressed by said content distribution means.

44. The surround sound system of claim 43, wherein said addressable loudspeaker further comprises:
a modem communicatively coupled to said system communication medium;
a means for amplifying a signal communicatively coupled to said modem; and
a speaker communicatively coupled to said signal amplifier;
wherein said modem is configured to be assigned a unique network identification.

45. The surround sound system of claim 44, wherein said unique network identification comprises one of an Internet protocol (IP) address or an Ethernet address.

46. The surround sound system of claim 45, wherein said content distribution means further comprises a modulator configured to both packetize audio signals received from said receiver and selectively route said packetized audio signals to one of said addressable loudspeakers using said unique network identification and said routing means.

47. A method for transmitting audio data to a loudspeaker comprising:
assigning a unique network identification to said loudspeaker;
receiving an audio signal in a signal distribution component;
packetizing said audio signal; and
routing said packetized audio signal to said loudspeaker using said unique network identification and a router.

48. The method of claim 47, wherein said packetizing said audio signal further comprises forming header information, wherein said header information includes said unique network identification.

49. The method of claim 48, wherein said routing said packetized audio signal to said loudspeaker further comprises:
introducing said packetized audio signal onto a network;
receiving said packetized audio signal in a router;
reading said header information; and
routing said packetized audio signal to said loudspeaker using said unique network identification.

50. The method of claim 49, wherein said routing said packetized data further comprises transmitting said packetized data over a signal communication medium.

51. The method of claim 50, wherein said signal communication medium comprises a home power line network.
